(19) United States
(12) Patent Application Publication
(10) Pub. No.: US 2023/0229924 A1
(43) Pub. Date: Jul. 20, 2023

(54) MODIFYING NEURAL NETWORKS BASED ON ENHANCED VISUALIZATION DATA

(71) Applicant: Intuitive Research and Technology Corporation, Huntsville, AL (US)

(72) Inventor: Kyle Jordan RUSSELL, Huntsville, AL (US)

(21) Appl. No.: 18/096,164

(22) Filed: Jan. 12, 2023

Related U.S. Application Data
(60) Provisional application No. 63/299,601, filed on Jan. 14, 2022.

(51) Int. Cl. G06N 3/082; G06T 17/20

(52) U.S. Cl. CPC G06N 3/082; G06T 17/20

(57) ABSTRACT

Techniques for updating a visualization of a neural network and for refining a neural network are disclosed. Network data is obtained, where this data describes the neural network. At least some of the network data is normalized. A visual representation of the neural network is generated. The visual representation includes a set of nodes. The visual representation further includes edges connecting various nodes. The visual representation is updated using the normalized network data. As a result of updating the visual representation using the normalized network data, a display of the nodes and/or of the edges is modified in a manner to reflect a relative relationship that exists between the nodes and/or the edges. The relative relationship is based on the normalized network data. The updated visual representation is then displayed.

### CROSS-REFERENCE TO RELATED APPLICATIONS

This application claims the benefit of and priority to U.S. Provisional Patent Application Ser. No. 63/299,601 filed on Jan. 14, 2022 and entitled “Modifying Neural Networks Based on Enhanced Visualization Data,” and which application is expressly incorporated herein by reference in its entirety.

### BACKGROUND

A “neural network” is a set of algorithms and computing constructs that are generally modeled after the human brain. At a high level, a neural network is designed to recognize patterns and then provide meaning to those patterns. Different types of data can be fed as input into a neural network, and that neural network can be trained and perhaps even tuned in a manner so as to process the input data and provide relevant output data.

Typically, a neural network includes a dense array of connecting processing nodes, similar to the neurons in a person's brain. Each node can be connected to other nodes that exist in layers above or below that node. Data is moved through the network, often in a feed-forward direction, and the node “fires” when it passes information on to a next node in the network.

Generally, a network analyzes data and makes a classification decision by assigning each node a “weight.” This weight represents the value of information that is provided to a particular node. Stated differently, the weight generally refers to how helpful the node was in correctly identifying and classifying information. When a node receives information from another node, that node determines a weight for the received information. Different weight thresholds can be established.

If the node's assigned weight to the information exceeds the threshold, then the information is permitted to be passed on to a next node; otherwise, the node does not pass on the information. As the neural network is trained, the weights and thresholds are refined and corrected in an effort to generate accurate and correct outputs. Training a neural network can take a considerable amount of time and a considerable amount of resources.

Currently, there are various techniques that can be used to “mutate” a neural network. By “mutate,” it is meant that various nodes and/or edges of the network can be modified or perhaps eliminated from the network. For instance, some systems allow a user to specify a so-called “mutation rate” or “mutation rate percentage.” Using this mutation rate, the neural network can then be subjected to various training processes over a number of iterations. Throughout these iterations, the neural network might be mutated. That is, the mutation can optionally occur over time and can optionally result in the creation or subtraction of a neuron. Such a process, however, is spontaneous and can be considered a “dumb” process in that there is no particular driving force as to why or how the network might change. In some cases, the mutation might actually result in the addition of neurons, thereby producing a more complex neural network than what was originally available.

Often, administrators of a network tend to focus on the output of the network as opposed to focusing on how the network is structured. What is needed, therefore, is an improved technique for training, visualizing, configuring, or even structuring a neural network. Furthermore, what is needed is an intelligent way to mutate or modify a neural network in a guided manner so as to not only increase the efficiency of the network but also to decrease the complexity of the network.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for updating a visual representation of a neural network.

After a selected number of iterations in which input data is fed into a neural network, some embodiments obtain network data describing the neural network. The network data includes state data describing a state of the neural network and structure data describing a structure of the neural network. At least some of the network data is then normalized. The embodiments generate a visual representation of the neural network. The visual representation includes a set of nodes comprising one or more input nodes, one or more hidden layer nodes, and one or more output nodes. The visual representation further includes edges connecting various ones of the nodes. The visual representation is updated using the normalized network data. As a result of updating the visual representation using the normalized network data, a display of the nodes and/or of the edges is modified in a manner to reflect a relative relationship that exists between the nodes and/or the edges. This relative relationship is based on the normalized network data. The embodiments then display the updated visual representation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of a neural network.

FIG. 2A illustrates an example architecture that can implement a process flow for updating a representation of a neural network. The process flow is shown in FIG. 2B.

FIG. 3 illustrates an example of an updated visualization of a neural network.

FIG. 4 illustrates another example of an updated visualization.

FIG. 5 illustrates how the visualization can surface or display additional information about nodes and edges in the neural network.

FIG. 6 illustrates how supplemental information can also be displayed with the visualization of the neural network.

FIG. 7 illustrates how other supplemental information can be displayed.

FIG. 8 illustrates how various portions of the neural network can be selected and emphasized in how they are displayed.

FIG. 9 illustrates an example process for filtering and refining a neural network.

FIG. 10 illustrates how a simplified neural network can be generated by following the disclosed principles.

FIG. 11 illustrates a flowchart of an example method for updating a visual representation of a neural network.

FIG. 12 illustrates a flowchart of an example method for refining a neural network.

FIG. 13 illustrates an example computer system capable of performing any of the disclosed operations.

### DETAILED DESCRIPTION

Embodiments disclosed herein relate to systems, devices, and methods for updating a visualization of a neural network and for refining a neural network.

In some embodiments, after a selected number of iterations in which input data is fed into a neural network, network data is obtained, where this data describes the neural network. Here, the network data includes state data describing a state of the neural network (e.g., perhaps the weights and thresholds for the nodes) and structure data describing a structure of the neural network (e.g., the number of layers, the number of nodes per layer, which nodes are connected to which other nodes, properties of the edges, etc.).

The embodiments normalize at least some of the network data. A visual representation of the neural network is generated. The visual representation includes a set of nodes comprising one or more input nodes, hidden layer nodes, and output nodes. The visual representation further includes edges connecting various nodes. The visual representation is then updated using the normalized network data. Notably, as a result of updating the visual representation using the normalized network data, a display of the nodes and/or of the edges is modified in a manner to reflect a relative relationship that exists between the nodes and/or the edges. The relative relationship is based on the normalized network data. The embodiments then display the updated visual representation.

In some embodiments, network data is obtained, where this data describes the neural network. The network data includes state data and structure data. The embodiments normalize at least some of the network data and then update a visual representation of the neural network using the normalized network data. As a result of the updates, a display of nodes and/or of edges in the neural network is modified in a manner to reflect a relative relationship that exists between the nodes and/or the edges. The relative relationship is based on the normalized network data. The embodiments also identify a particular node in the neural network whose influence on the neural network is less than a threshold influence (e.g., a weight of a node might be below a defined threshold). A new configuration for a subsequent neural network is generated by removing the particular node from the previous neural network. The new or subsequent neural network is then configured based on the new configuration.

As used herein, the term “influence” generally refers to a node's/edge's relative weight, bias, and/or threshold as compared to other nodes/edges in the network. For example, higher weights, biases, and/or thresholds results in the node having a higher “impact” or “influence” on the network. Each node in a layer has or is associated with an activation function. Generally, an activation function refers to a criteria that has to be met in order for a node to switch on or off. That criteria can be or can include a threshold requirement or perhaps even some other nonlinear behavior requirement. Regarding the weights, the connections that are coming into a node are subjected to a multiplication operation using the weights. The resulting product for that node is then accumulated for all of the input nodes of a particular node. Such an operation occurs for each node in a layer. Thus, the larger value a weight has, the more influential the corresponding node will be.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments bring about numerous and substantial benefits and improvements to the technical field. For instance, the embodiments provide a new developer tool to developers, where this tool improves the visual display of information related to a neural network. Now, developers can easily and intuitively identify the relative amount by which each node and/or edge in a neural network impacts the network overall. Furthermore, the developers are now provided with enhanced information that they previously would not have been able to easily see when interacting with the visualizations of a neural network.

The embodiments also improve the technical field by providing a dynamic (e.g., updated in real-time) visualization of the neural network. In contrast, traditional visualizations of neural networks were static and provided very little information. That is, traditional visualizations failed to provide updated, real-time views of the network as it changed; furthermore, those traditional visualizations failed to reflect real-time changes to the network's structure and node weights. The disclosed embodiments do provide for the real-time view of updates to a network's structure and state, as well as up-to-date views of the node's weights. Even further, as changes are made to a network's structure (e.g., such as perhaps on the backend), the embodiments can dynamically update the visualization in real-time to show these changes.

The embodiments also allow for a neural network to be modified, refined, and enhanced. In doing so, significant improvements in computing efficiency and performance can be realized. To achieve these benefits, the embodiments display which nodes and/or edges in the neural network have the greatest influence or impact on the network. Nodes that do not achieve at least a threshold level of influence are also identified. These less-influential nodes can then be filtered or removed from the neural network. A new network can then be configured, where this new network is a simplified version of the previous network, but this new network can provide substantially the same level of functionality as the previous, more complex network. In this sense, significant improvements in computing efficiency can be achieved by intelligently reducing the complexity of neural networks. Reductions in hardware and the amount of training time can also be achieved.

By having a simpler network, the embodiments can also improve the deployment of that network to various endpoints, such as by reducing bandwidth and processor usage. Less data can also be collected, resulting in additional efficiencies. As a simplified example, if a previous network included four input nodes, but the embodiments were able to reduce that number to a single input node, now less data will need to be collected because only a single input node is operating to collect or analyze data. In this manner, the embodiments are able to generate a high quality result using less input data. Accordingly, these and numerous other benefits will now be discussed in detail throughout the remaining portions of this disclosure.

### Neural Networks

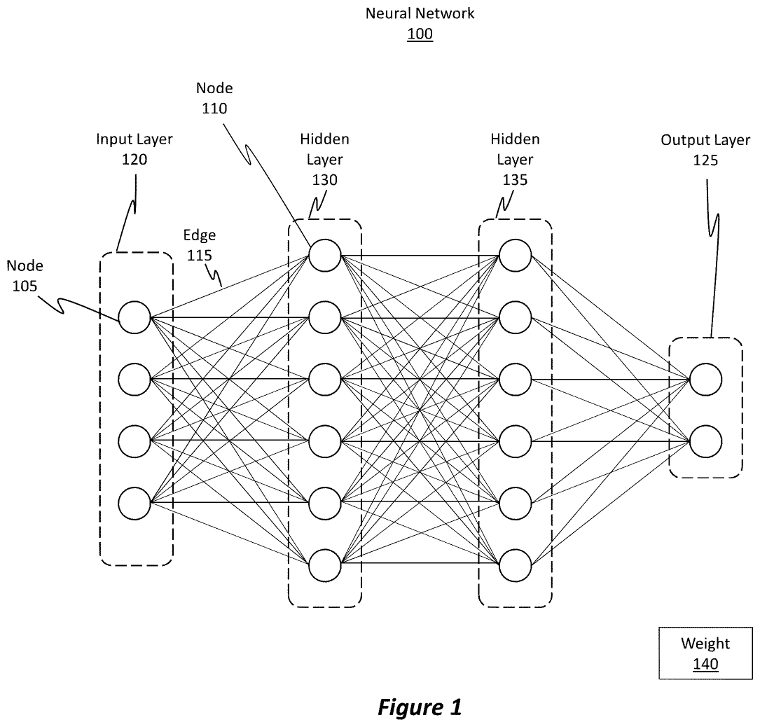

Attention will now be directed to FIG. 1, which illustrates an example neural network 100. As generally described earlier, the neural network includes various nodes, such as node 105 and node 110. An edge 115 is shown as connecting the nodes 105 and 110.

An edge generally represents the weights and/or the biases for linear transformations that occur between different layers. A node generally represents a computational unit that includes an input connection (e.g., a weighted input connection), a computational function (e.g., a transfer or computational function that combines inputs in a defined manner), and an output connection.

The neural network 100 includes various layers, such as the input layer 120, the output layer 125, and a number of middle or intermediary layers referred to as hidden layers (e.g., hidden layers 130 and 135). Each of the nodes (e.g., node 105 and 110) is assigned or attributed a respective weight 140, as mentioned earlier.

The neural network 100 can be any type of (artificial) neural network. Example types include, but are not limited to, fully connected neural networks, convolution neural networks (CNN), and recurrent neural networks (RNN). A neural network that has one or more hidden layers is referred to as a deep neural network. The hidden layers are sometimes also referred to as the computation layers because those layers perform a majority of the computational analysis.

### Architectures and Process Flows

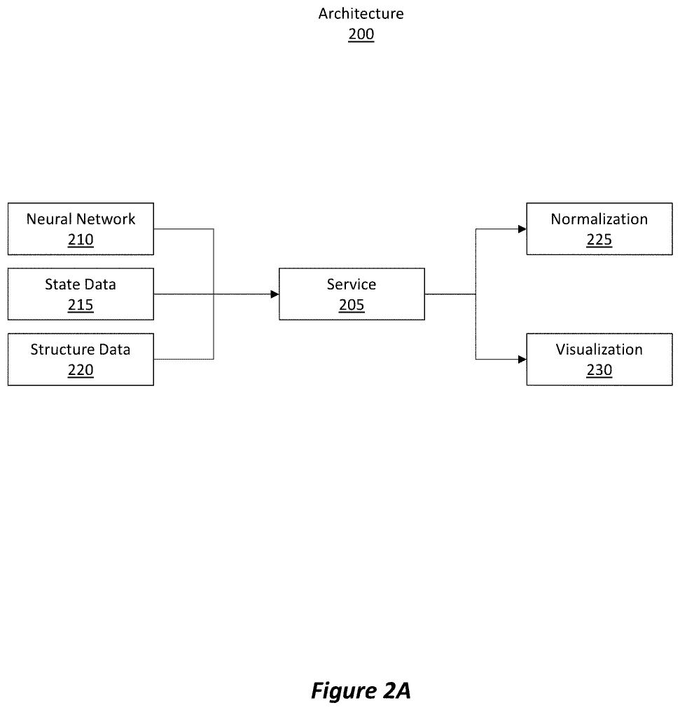

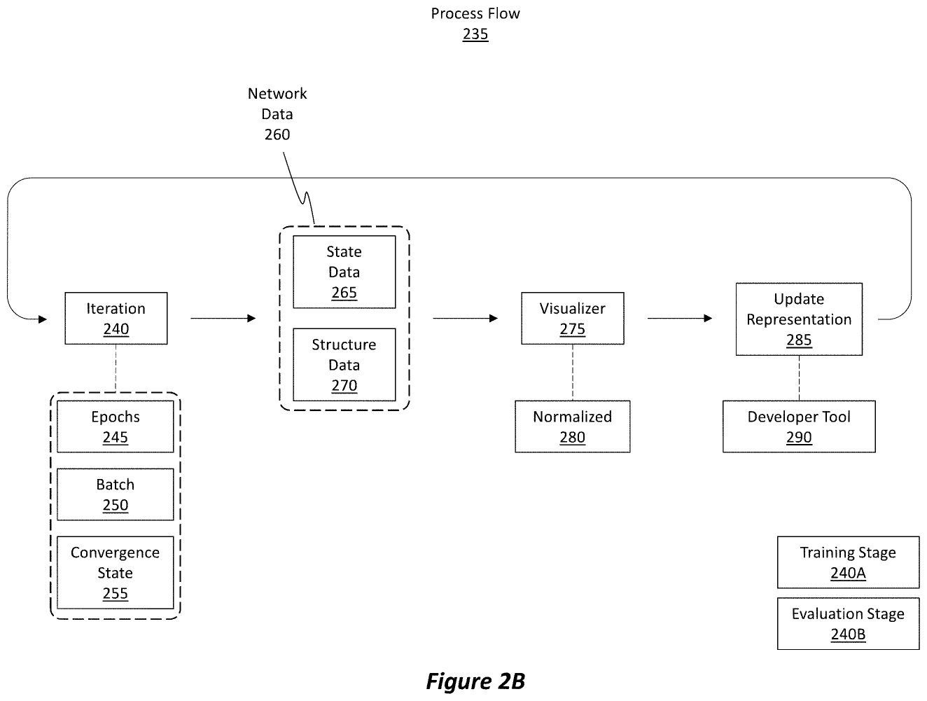

Having just described a neural network, attention will now be directed to FIGS. 2A and 2B. FIG. 2A illustrates an example architecture 200 that is able to perform the process flow described in FIG. 2B.

In particular, architecture 200 of FIG. 2A is shown as including a service 205. Service 205 can optionally be a cloud service operating in a cloud environment. In some cases, service 205 can be a local service operating on a local client device. In some cases, service 205 can be a hybrid combination of both a cloud and a local service.

Service 205 can optionally include a machine learning (ML) engine that is designed to optimize a different neural network. That is, in some cases, a first neural network, artificial intelligence, or machine learning engine can be tasked with analyzing and modifying a second neural network, artificial intelligence, or machine learning engine.

Service 205 is shown as being able to access a neural network 210. Service 205 is also able to receive various different inputs pertaining to that neural network 210. These inputs include, but are not limited to, state data 215 of the neural network 210 and structure data 220 of the neural network 210.

The service 205, as will be described in more detail shortly, performs a normalization 225 operation on the weights in the neural network 210. The service 205 is then able to generate a visualization 230 to provide the opportunity to modify the structure of the neural network 210.

Attention will now be directed to FIG. 2B, which illustrates an example process flow 235 designed to improve how neural networks are visualized as well as how those networks are configured. The process flow 235 can be implemented using the neural network 100 from FIG. 1. Furthermore, the process flow 235 can be performed by the service 205 from FIG. 2A.

When data fully passes through the neural network, the neural network has completed an iteration 240 on that data. The iteration 240 can be a part of a training stage 240A, where the neural network is being trained on data, or the iteration 240 can be a part of an evaluation stage 240B, such as perhaps where the neural network is being tuned or perhaps where the neural network is being critiqued to determine how accurate its results are.

The process flow 235 can be triggered in response to the neural network undergoing any number of iterations. An epoch 245 also refers to a scenario where data fully runs through the neural network. A batch 250 refers to the number of samples the neural network operates on at a same time. In accordance with the disclosed principles, the number of samples can be fully customizable. The convergence state 255 refers to a scenario where the neural network has essentially produced a satisfactory result.

The disclosed process flow 235 can be triggered when a selected number of epochs have transpired, when a selected number of batches has been processed, and/or when the neural network reaches a convergence state, as generally shown by the iteration 240. That is, in some embodiments, the selected number of iterations is based on a determination as to whether the neural network has reached a convergence state. If the network is in the convergence state, then the iterations can end.

In response to the iteration 240 being detected, the embodiments acquire or expose network data 260. The network data 260 includes state data 265 (e.g., the state data 215 from FIG. 2A) describing the current state of the neural network (e.g., weights, biases, and thresholds assigned to the network constructs, such as the nodes and edges) as well as structure data 270 (e.g., structure data 220 from FIG. 2A) describing the current structure of the neural network (e.g., the organizational layout of the nodes, as they are represented in the input layer, the hidden layers, and the output layer).

The network data 260 is then piped or delivered to a visualizer 275. The visualizer 275 is configured to normalize the network data 260 for the nodes and edges, as shown by normalized 280 (e.g., as also represented by normalization 225 from FIG. 2A). By “normalized,” it is meant that the visualizer 275 changes the values in a dataset, such as the network data 260, to use a common scale. Such an operation is also performed without losing or distorting the differences that exist in the ranges of the data.

To perform this normalization process, some embodiments obtain or access the weights for each layer in the neural network. That is, each layer is normalized separately from the other layers.

For instance, the embodiments access the weights that connect nodes from a previous layer and to a next layer. The embodiments identify the weight having the highest value and identify the weight having the lowest value. The embodiments then compute a range that exists between these two weights, such as by subtracting the lowest valued weight from the highest valued weight. After this range is determined, the embodiments divide each respective weight in the layer by the computed range to thereby “normalize” the weights with respect to one another and with respect to a given layer.

Normalizing the weights is beneficial because in traditional neural networks, the weights in the network can actually expand or “explode.” For instance, it is often the case that the deeper into a neural network one goes, the more chaotic or larger (in discrepancy relative to one another) the weights become.

In this manner, the weights of a given layer are normalized with respect to one another. Notably, the weights of a first layer are typically not normalized against the weights of a second layer. Thus, there is a level of separation or isolation between the different layers and how those layers are normalized.

In some implementations, the weights can have a positive value or a negative value. In some cases, each weight is normalized against its corresponding absolute value. In other cases, each weight is normalized against its raw value, even if that value is negative. A network node can contribute to the network in a negative way such that it might be the case that the node has a large (negative) influence on the final result. If a weight has a negative value, that negative value is used to determine the range. As an example only, suppose the lowest valued weight in a given layer had a value of −0.2 and the highest valued weight in the layer had a value of 0.6. The range would be computed as 0.6−(−0.2)=0.8. Each weight can then be divided by this computed range. As indicated above, in some cases, the absolute value of each weight is divided by the range whereas in other scenarios the raw value of each weight is divided by the range.

With the normalized data (i.e. the weights), the visualizer 275 then updates a representation of the neural network, as shown by update representation 285. This updated representation provides a highly useful developer tool 290 that developers can use to understand how the neural network is behaving. The developer tool 290 can also be used to configure new versions of a neural network, where this new version is optimized and simplified. Further details on these aspects will be provided later.

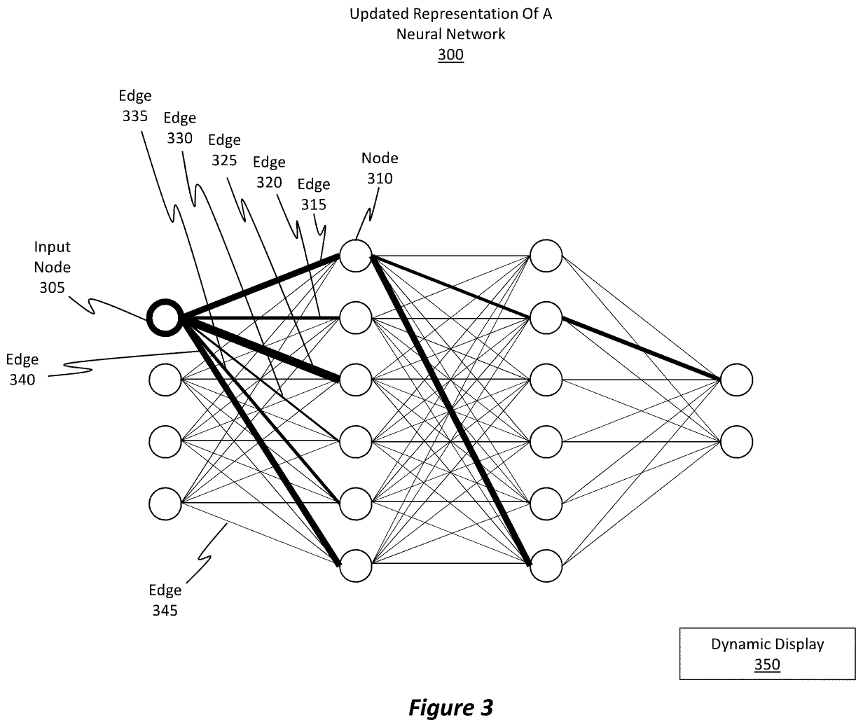

FIG. 3 shows an updated representation of a neural network 300, which is produced using the process flow 235 of FIG. 2B. This updated representation shows a number of nodes, such as input node 305 (which is representative of node 105 from FIG. 1) and node 310 (which is representative of node 110 from FIG. 1). The representation also shows a number of edges, such as edge 315 (which is representative of edge 115 from FIG. 1) and edges 320, 325, 330, 335, 340, and 345.

Notice, some of the edges and/or nodes are shown as being “emphasized” in appearance. For instance, the border of input node 305 is shown as being thicker than some of the borders of the other nodes. Similarly, the thickness of some of the edges is shown as being thicker than some of the other edges. To illustrate, edges 315, 320, 330, 335, and 340 are thicker in appearance than edge 345. Edge 325 is the thickest of them all.

In some cases, the thickness of the lines corresponds to the state data that has been acquired (e.g., the weights, biases, and/or thresholds each node has). Relatively higher weights (i.e. a higher influence in the classification process) correspond to relatively thicker lines. Relatively lower weights correspond to relatively thinner lines. In some cases, numerical values of the state data (e.g., the weights) can also be displayed next to their corresponding nodes and/or edges.

Optionally, in some cases, only the nodes and edges associated with the input nodes, or rather, the input layer (i.e. the first layer in the neural network) are emphasized, such as by having thicker lines. Optionally, nodes and edges that are not in the input layer (e.g., such as those in the hidden layer or the output layer) might not have their appearances modified. On the other hand, in some cases, all nodes and edges can have their appearances modified to some degree based on their relative influence on the network as a whole.

In some cases, whether a node or edge will have its appearance modified can be based on the size of the overall neural network. Relatively smaller networks (e.g., such as those having less than a threshold number of total nodes) might have the appearances of all of their nodes and edges modified. Relatively larger networks (e.g., such as those having more than the threshold number of total nodes), on the other hand, might have the appearances of only the input layer nodes and corresponding edges modified. Modifying all of the appearances in a large network can result in an overabundance of information being presented to a user.

In some cases, specific layers can be selected. Any nodes and edges associated with that layer can have their appearances modified while nodes and edges not associated with that layer might not have their appearances modified. In some cases, multiple layers can be selected and the modification in appearance can be performed for the nodes and edges associated with those selected layers. Thus, the modification might not occur until a layer is selected.

In some cases, a weight threshold can be defined. Nodes whose weights exceed the threshold can have their appearances modified while nodes whose weights do not exceed the threshold might not have their appearances modified.

Typically, the embodiments determine a node's influence as compared to the neural network as a whole. In some instances, however, different criteria can be used to determine a node's “relative” influence. As a first example, a user can select any number of nodes and then trigger the system to determine the relative influences of those nodes as between each other (as opposed to the network as a whole). As another example, a user can select any number of layers and then trigger the system to determine the relative influences of those nodes as between each other. Accordingly, different techniques or comparison factors can be used to determine a node's “relative” influence. Often, nodes within the same layer can be compared and contrasted because they are commonly normalized. As indicated above, however, in some instances, nodes across different layers can be compared and contrasted, despite being normalized differently.

In some cases, the visual “emphasis” or modification in appearance can be achieved in different ways. For instance, in addition or as an alternative to adjusting the thickness of an edge or node, an edge or node can be “emphasized” by modifying its color, transparency, flashing status, or even the type of line style (e.g., solid line, dotted line, dash dot dot line, and so on). Accordingly, different techniques can be used to provide the disclosed “emphasis.”

A majority of the remaining disclosure will focus on the example scenario in which a line's “thickness” represents a particular influence. One will appreciate, however, how the discussion can be applied to other types of emphasis techniques as well.

In accordance with the disclosed principles, the thickness of an edge (or node) represents the relative influence a particular node (e.g., an input node) has on the neural network as a whole. For instance, based on the thickness of the edges stemming from the input node 305, the input node 305 has a relatively higher degree or amount of influence on the neural network as a whole as compared to any of the other nodes. That is, the weights, biases, and/or thresholds assigned to input node 305 are relatively higher than the weights, biases, and/or thresholds assigned to other nodes.

The state data (e.g., the weights, biases, and/or thresholds) can be updated and acquired in real time. Consequently, the resulting visualizations (e.g., the modifications in appearance, such as line thickness) can also be updated in a dynamic, real-time manner.

By displaying the nodes and the edges in this dynamic manner, the embodiments are able to provide a heightened level of information about the state (and even structure) of the neural network as compared to traditional systems. Furthermore, the disclosed embodiments are able to provide a dynamic display 350 of the neural network as opposed to a static display. By dynamic display, it is meant that the embodiments are able to provide enhanced, supplemental information during various iterations to illustrate how the neural network evolves over the various iterations, such as by highlighting or emphasis changes to weights, biases, and/or thresholds. By providing this enhanced supplemental information, it is also the case that developers can configure new, optimized neural networks, where these optimized neural networks are simplified yet produce substantially similar results as their more complex variants or predecessors. Further details on these aspects will be provided later.

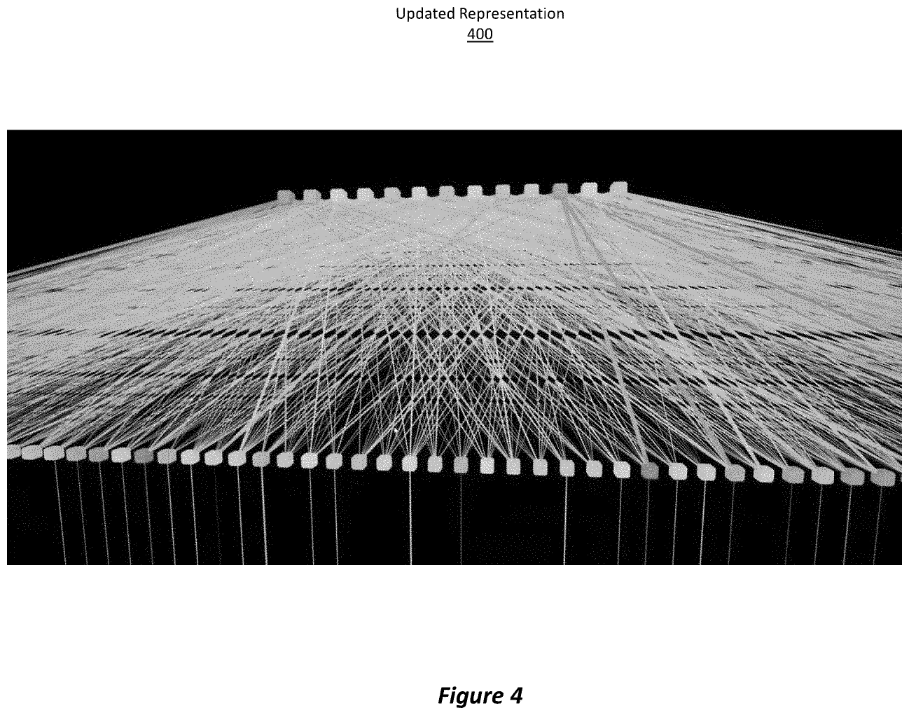

FIG. 4 shows a significantly more complex neural network than the one presented in FIG. 3. FIG. 4 also shows an updated representation 400, which is generated by following the process flow 235 of FIG. 2B. Notice, some of the various nodes and/or edges are illustrated in an enhanced or emphasized manner, such as perhaps differences in thickness, color, transparency, and so on.

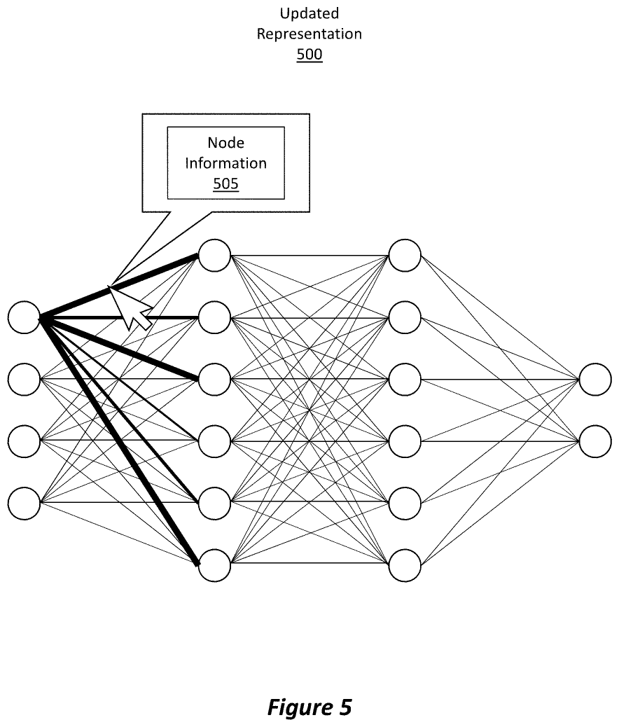

FIG. 5 shows another embodiment of an updated representation 500, which is representative of the updated representations mentioned thus far. In accordance with the disclosed principles, the embodiments enable a user or developer to hover a cursor over any of the nodes or edges in order to surface or display supplemental information about that portion of the neural network. As an example, the user in FIG. 5 is hovering his/her cursor over an edge, and this hovering action triggered the display of node information 505. The node information 505 can display information about one or more nodes as well as the edge, such as perhaps the type of computation a node performs, the weights, biases, thresholds, the position of the entity within the neural network (e.g., is it in the input layer, the hidden layers, the output layer), and so on. Accordingly, the node information 505 can display the weights of the nodes and any other information that is relevant or pertinent to the node or edge.

Additionally, or alternatively, some embodiments include logic for auto-surfacing information based on defined thresholding logic (or perhaps even artificial intelligence) to draw the user's attention to a particular feature in the displayed neural network. For instance, the auto-surfaced information can include details about a node, edge, weights, biases, and so forth. In some cases, the logic might be configured to trigger a notice in order to capture or draw the user's attention, such as in a scenario where an issue has been detected for the network.

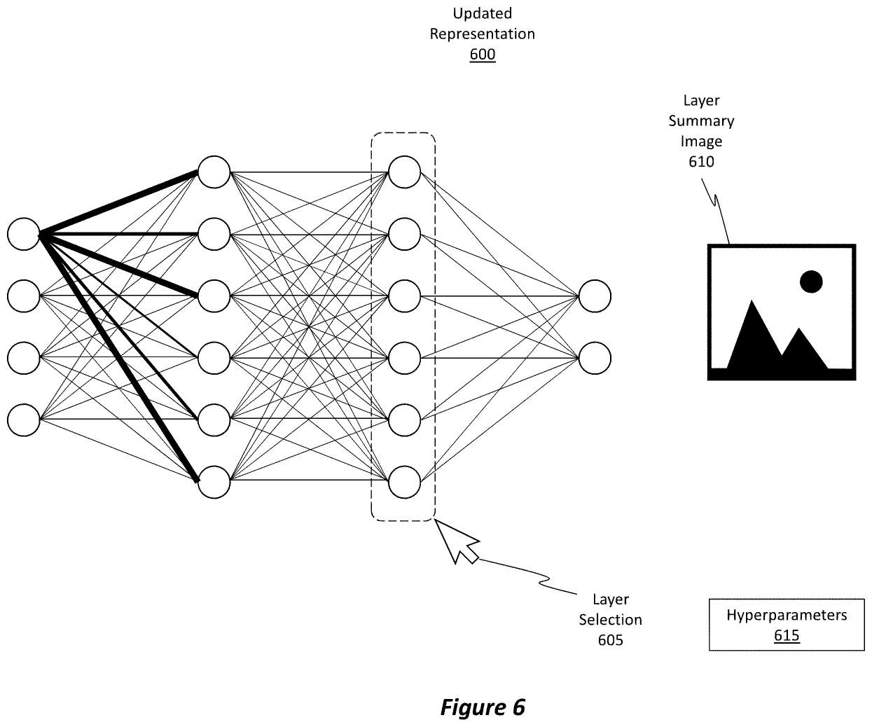

FIG. 6 shows another updated representation 600. Here, the user is selecting or perhaps hovering his/her cursor over a particular layer, as shown by layer selection 605. In response to this action, the embodiments can optionally trigger the display of a so-called layer summary image 610. The layer summer image 610 generally represents a portion of data (e.g., perhaps an image, though other types of data can be displayed or provided to the user, such as perhaps audio data) that this selected layer is currently examining.

In some cases, the hyperparameters 615 of the layer can also be displayed. Generally, a hyperparameter includes the number of neurons, the activation function, the optimizer, perhaps the learning rate, the batch size, and even perhaps the epochs. In accordance with the disclosed principles, the embodiments can surface, expose, or display these hyperparameters 615. In some cases, these hyperparameters 615 can be adjustable or modifiable within the updated representation 600.

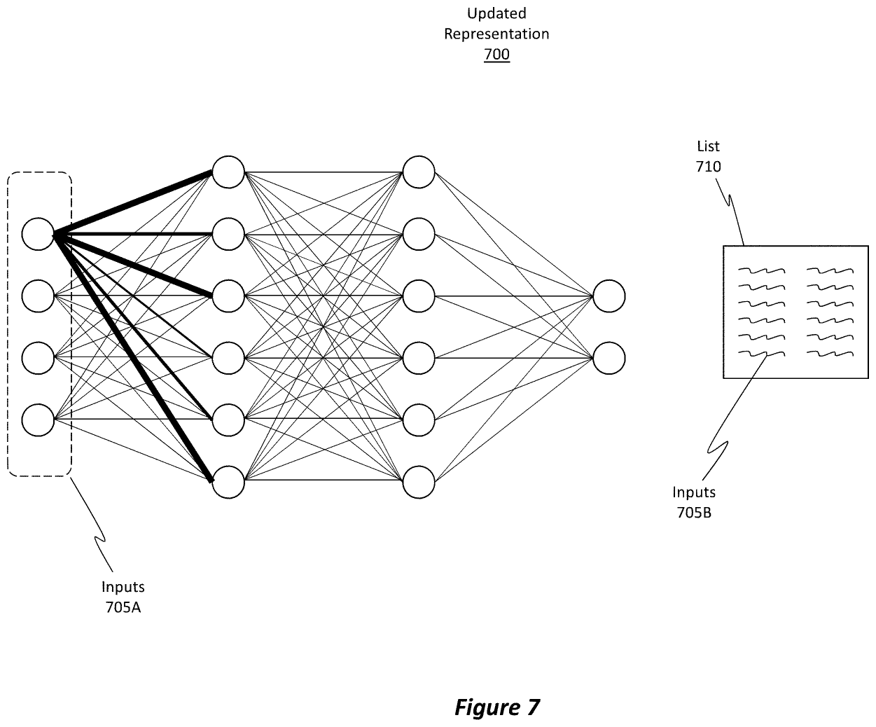

FIG. 7 shows an updated representation 700, which is representative of the updated representations mentioned thus far. In this scenario, FIG. 7 calls out a set of inputs 705A (i.e. input nodes). The representation or visualization is also emphasizing various ones of the edges to show the relative overall influence on the neural network the various input nodes have. The disclosed embodiments are further able to display or surface a list 710, which can include a ranked ordering of the inputs 705B, which correspond to the inputs 705A.

The list 710 can be configured to rank the inputs based on their relative influence on the network. In some cases, the ranking can be from highest influence to lowest influence. In some cases, the ranking can be from lowest influence to highest influence. In some cases, the list 710 can display the relative ranking not as compared to all other nodes/edges in the network but rather as compared to certain other nodes/edges that have been selected, as described earlier. In some cases, interacting with the network (e.g., perhaps by hovering or selecting components in the network) might change the state of the list as well. In this sense, interacting with the list can optionally result in modifications to the network, and interactions with the network can optionally result in modifications to the list.

Each input in the list 710 is also selectable. That is, a user can select any one of the items provided in the list 710. When an item or input is selected in the list 710, the corresponding node or edge in the representation can be highlighted or emphasized in some manner so as to enable the user to readily identify the selected item. In some cases, the node or edge can be displayed in a flashing manner, or it can change in appearance (e.g., color, transparency, etc.). In some cases, when a node or edge is selected in the list 710, all other nodes and edges are modified to be displayed at a certain transparency level so that the selected node or edge “pops” out to the user and is easily viewable within the visualization/representation. When the selected node or edge is no longer selected, the transparency levels are returned to their original level (e.g., perhaps 0% transparency).

In some cases, multiple items in the list 710 can be selected at the same time, and those selected nodes or edges can be emphasized in the visualization or representation using any of the techniques mentioned herein. As will be discussed in more detail later, the display of the list 710 enables developers to identify which input nodes provide which levels of influence on the network as a whole or perhaps as compared to selected other ones. With this information, a developer can delete various input nodes from the network and then configure a new network based on the new configuration.

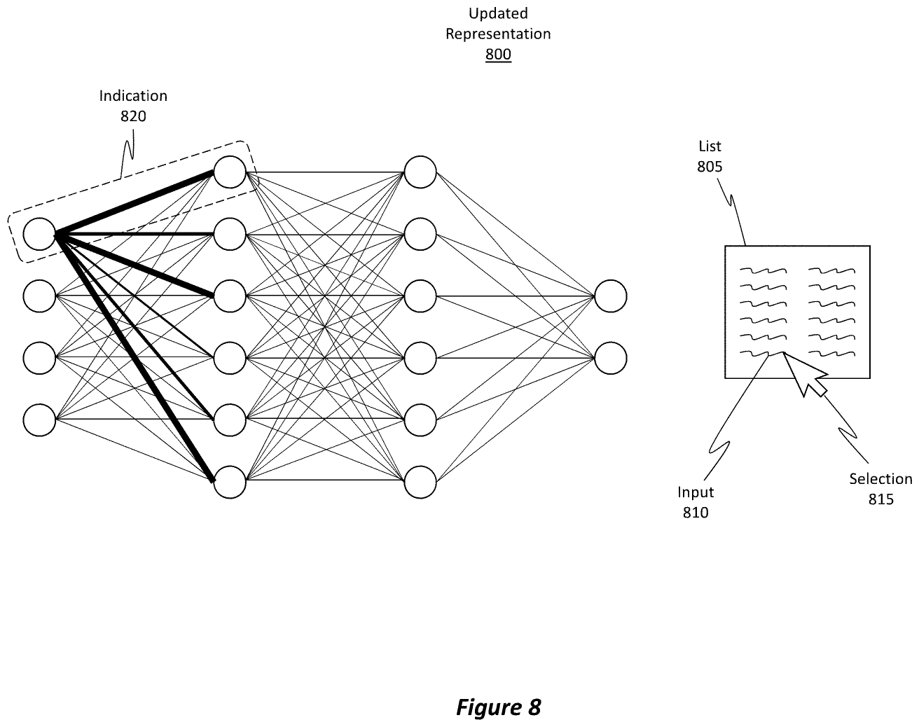

That is, within the user interface that provides the updated representation 700 (including the list 710), the user can select items within the list 710 and have those items marked for potential deletion. In some cases, a preview of what the neural network would look like with the selected items deleted can be generated and displayed to the user. In some cases, the preview can also display metric data, such as perhaps how different (or close) the two networks are relative to one another in terms of hardware requirements, potential training times, closeness or accurateness in terms of a resulting output, and so on. Accordingly, the list 710 can be used to select, remove, delete, or filter input nodes and other network constructs from the neural network. FIG. 8 provides additional details.

FIG. 8 shows an updated representation 800, which is representative of the updated representation 700 of FIG. 7. Here, a list 805 is provided that includes various inputs, such as input 810, which is currently being selected and/or hovered over, as shown by selection 815. In response to the selection 815 (or hovering), an indication 820 is displayed in the representation of the neural network, where this indication 820 corresponds to the input 810 that was being selected in the list 805.

When an input is selected in the list 805, further information can also be displayed in addition to the modified or emphasized view of the input. For instance, weighting information, dependency information, or any other information can be displayed in a popup window at a location proximate to the emphasized network construct.

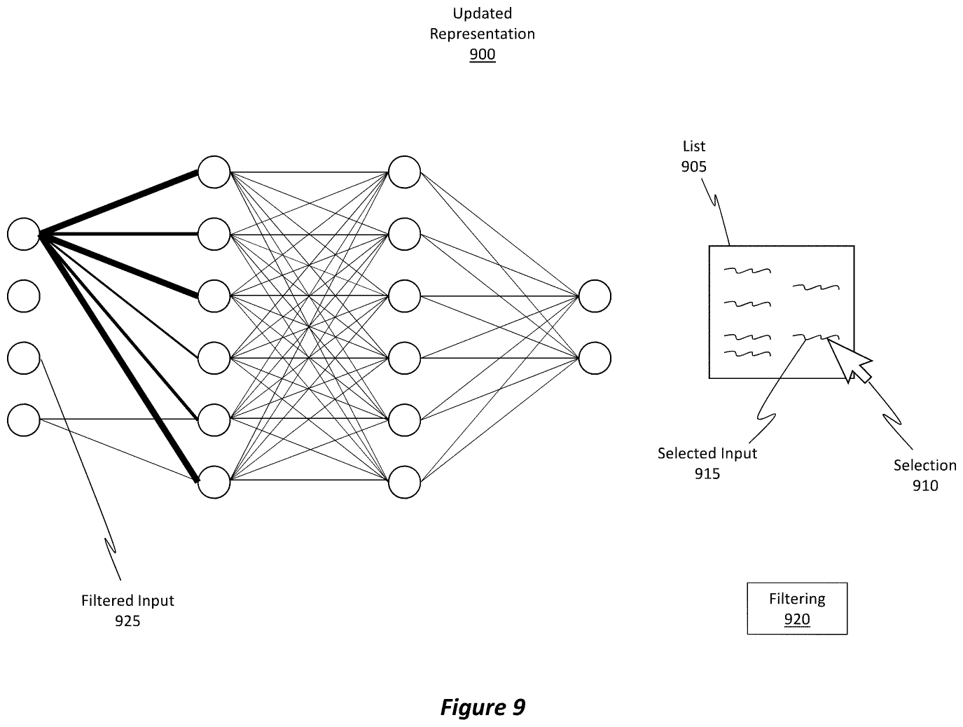

FIG. 9 shows an updated representation 900 that includes a list 905 and a user making a selection 910 of a particular selected input 915 in the list 905. In some embodiments, after being selected in the list 905, the selected input 915 can be removed or filtered (e.g., as shown by filtering 920) from the neural network. For instance, the filtered input 925 is shown has being removed from the neural network by removing edges that are attached to that node as well as by potentially entirely removing the node from the network.

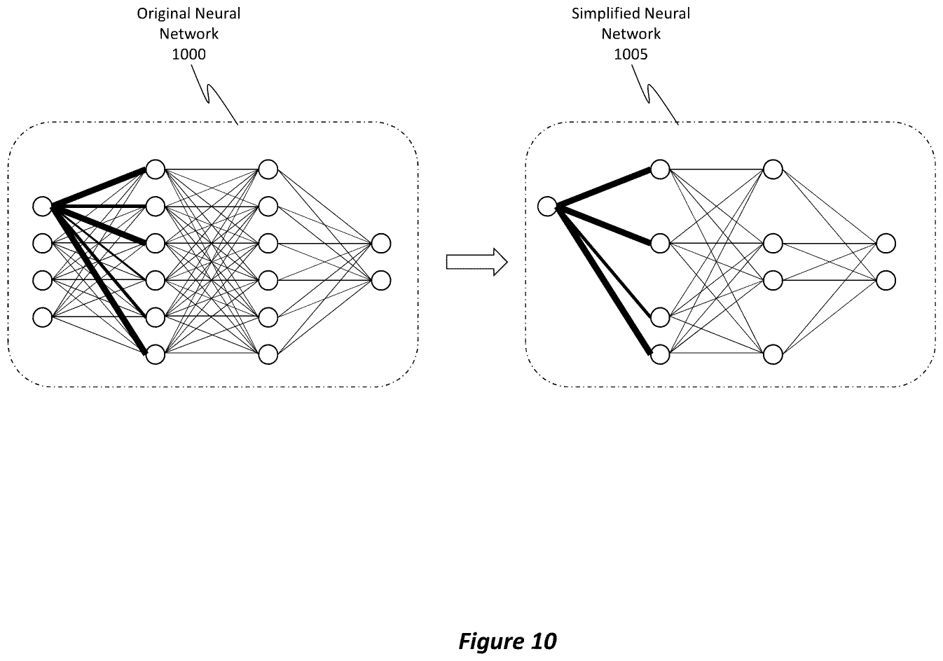

FIG. 10 shows an original neural network 1000. After a number of filtering operations, the simplified neural network 1005 results. Notice, the simplified neural network 1005 includes fewer nodes and/or edges than the original neural network 1000. In this scenario, the user/developer elected to remove a number of the nodes from the neural network based on a determination that those nodes only marginally influenced the neural network. Thus, their removal could significantly simplify the neural network without compromising the network's integrity or ability to accurately classify data. Accordingly, the disclosed embodiments provide for the ability to refine and simplify neural networks by intelligently identifying which nodes in the network have the relatively highest influence in the classification process and by intelligently filtering nodes that have relatively lower influence in the classification process.

As mentioned earlier, the embodiments can optionally display metrics that detail comparisons between the original neural network 1000 and the simplified neural network 1005. Such metrics can include an indication on the differences in the number of nodes and edges that exist between the two networks. The metrics can include the differences in the amount of hardware and processor usage between the two networks. The metrics can also include an estimated difference in the amount of training time that would occur when using the two different networks. The metrics can also include differences in the accuracy levels for outputs produced by the two networks. Although the above examples focused on metrics that indicated “differences,” the metrics can also display absolute values. For instance, the amount of hardware to service the original neural network 1000 might be “A” while the amount of hardware to service the simplified neural network 1005 might be “B.” The metrics can display these absolute values as well as a computed relative value (e.g., A minus B or B minus A).

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

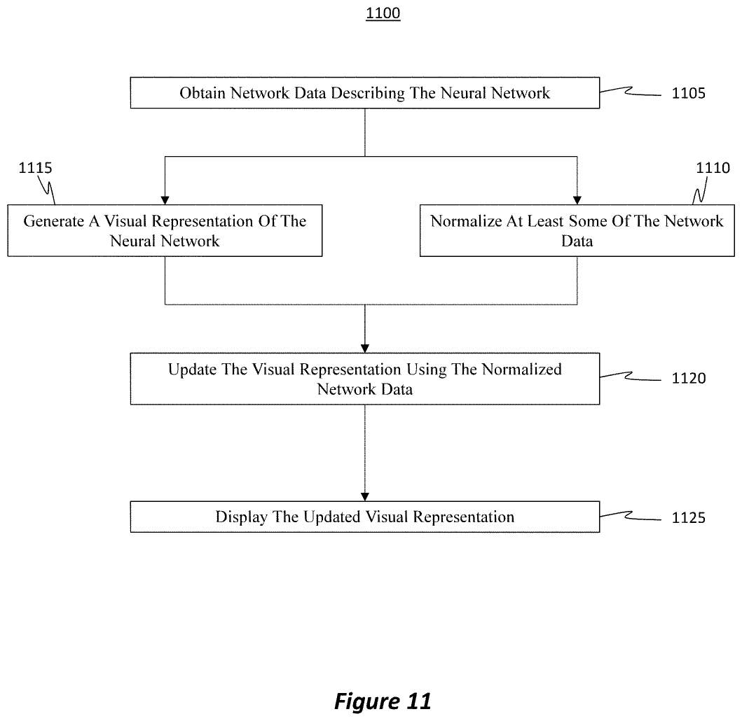

Attention will now be directed to FIG. 11, which illustrates a flowchart of an example method 1100 in which a computer system can be configured to update a visual representation of a neural network (e.g., the neural network 100 of FIG. 1). Method 1100 can be implemented by the service 205 from FIG. 2A.

Method 1100 includes an act (act 1105) of obtaining network data describing the neural network. The network data includes state data describing a state of the neural network. The network data also includes structure data describing a structure of the neural network. Optionally, the network data can include weights for nodes in the network. For example, the state data can include weights and thresholds for the nodes.

In some cases, the process of obtaining the network data is performed after a selected number of iterations in which input data is fed into a neural network. In some cases, the selected number of iterations are training iterations in which the neural network is being trained. In some cases, the selected number of iterations are evaluation iterations in which the neural network is being evaluated. In some implementations, the selected number of iterations is based on an epoch in which a data set is executed in its entirety by the neural network. Optionally, the selected number of iterations can be based on a batch size that details a number of samples that are executed by the neural network at a same time (e.g., perhaps the batch size is at least 30 samples, 40 sample 50 samples, 60 samples, and so on). In some implementations, the selected number of iterations is at least two iterations. Optionally, the selected number of iterations can be based on a determination as to whether the neural network has reached a convergence state.

In act 1110, at least some of the network data is normalized. In some cases, the normalization process is performed against the absolute value rather than the raw value. Using the absolute value can be beneficial in situations where the node negatively contributes to the network. In some cases, the raw value is used.

The normalization process can include identifying weights for a subset of nodes that are included in the same layer of the neural network. The normalization process can further include computing a range for the weights. For instance, the embodiments can identify a first weight having a highest value in a particular layer. The embodiment can also identify a second weight having a lowed value in the layer. The range can be computed by subtracting the lowest value from the highest value.

Optionally, an absolute value for each weight can be computed. Each weight is then normalized by dividing each weight by the computed range. Optionally, the normalization process can be performed by dividing each weight's absolute value by the computed range. In other scenario, each weight's raw value can be divided by the computed range. In some cases, a raw value for at least one weight is negative. The normalization process can occur for each respective layer of the neural network. It may be the case, then, that each respective layer of the neural network is normalized differently.

In parallel (or perhaps in serial, such as either before or after, or perhaps asynchronously) with act 1110, act 1115 includes generating a visual representation of the neural network. The visual representation includes a set of nodes comprising one or more input nodes, one or more hidden layer nodes, and one or more output nodes. Furthermore, the visual representation includes edges connecting various ones of the nodes. Generating the visual representation can be performed using a shader. In another embodiment, generating the visual representation can be performed using a three-dimensional (3D) mesh.

In act 1120, the visual representation is updated using the normalized network data. As a result of updating the visual representation using the normalized network data, a display of the nodes and/or of the edges is modified in a manner to reflect a relative relationship that exists between the nodes and/or the edges. Notably, the relative relationship is based on the normalized network data. In some cases, the process of modifying the display of the nodes and/or of the edges includes modifying a displayed thickness of the nodes and/or edges. Optionally, the modification can include modifying a border of at least one node.

As an example, FIG. 3 showed how the thicknesses of the various edges and/or nodes can be modified to reflect their relative influence on the neural network. In some cases, relatively thicker lines represent more influence while relatively thinner lines represent less influence. The term “influence” generally refers to a node's/edge's relative weight, bias, and/or threshold as compared to other nodes/edges in the network.

In this sense, the relative relationship that exists between the nodes and/or the edges and that is displayed via the visual representation can be provided to illustrate a relative impact that each of the input nodes has on the neural network. For example, higher weights, biases, and/or thresholds results in the node having a higher “impact” or “influence” on the network. Optionally, the process of updating the visual representation can be performed after the neural network reaches a convergence state.

In some embodiments, a shader is used to generate and optionally update the visual representation of the neural network. That is, the shader is one mechanism for drawing and displaying a neural network on a computer screen. The shader can draw the neural network in a volumetric manner.

In some implementations, high-level shader language (HLSL) is used to generate and/or update the visual representation. As an example only, some embodiments pipe JSON code that includes the state data and optionally the structure data. The embodiments interpret that data into native data structures. These native data structures can then be fed into shader code, which can either run on the GPU or on the CPU. Subsequently, the visuals can be updated to include the new/supplemental information (e.g., the state data). Use of the shader enables the embodiments to perform the visualization operations in a relatively fast manner. Different visualization techniques, however, can be used. For instance, a particle system can optionally be used to draw and display the neural network. A particle system comprises a series of individual three-dimensional (3D) meshes that can be used to display content. In some implementations, the neural network can be displayed using a single 3D mesh by manipulating the various vertices of that single 3D mesh.

In some implementations, the process of modifying the display of the nodes and/or the edges in the manner to reflect the relative relationship that exists between the nodes and/or the edges includes modifying a thickness of a first edge that connects a first node and a second node. The process can further include modifying a thickness of a second edge that connects a third node and a fourth node. Here, the thickness of the first edge can be thicker than the thickness of the second edge. Furthermore, the thickness of the first edge can be thicker than the thickness of the second edge as a result of the first node being associated with a relatively higher network weight than a network weight that is associated with the third node.

Act 1125 then includes displaying the updated visual representation. Any of the updated representations described herein can be representative of the representation recited in method 1100.

In some embodiments, the process of updating the visual representation is performed dynamically (e.g., perhaps in real-time). As a consequence, the visual representation is not necessarily static. In some cases, hovering a cursor over a particular node or a particular edge triggers the display of at least some of the normalized network data.

In some cases, a ranked list is displayed proximately to the updated visual representation. This ranked list can be configured to rank the nodes based on a level of influence each node has on the neural network (or perhaps relative to a selected number of other nodes), such as the level of influence each node has in contributing to the classification process. In some cases, a user can select a node within the list. Here, the selection of a particular node within the ranked list can optionally trigger an emphasized visualization of the particular node within the updated visual representation. In some cases, hovering a cursor over a particular node within the ranked list triggers an emphasized visualization of the particular node within the updated visual representation. Selection of a node can also trigger the filtering or removal of that node.

Some embodiments can be configured to display a layer summary image. This layer summary image can be displayed in response to a particular layer within the visual representation being selected.

In some implementations, the updated visual representation enables control of hyperparameters of a layer within the neural network. The updated visual representation can also provide for the ability to filter or delete various nodes from the network.

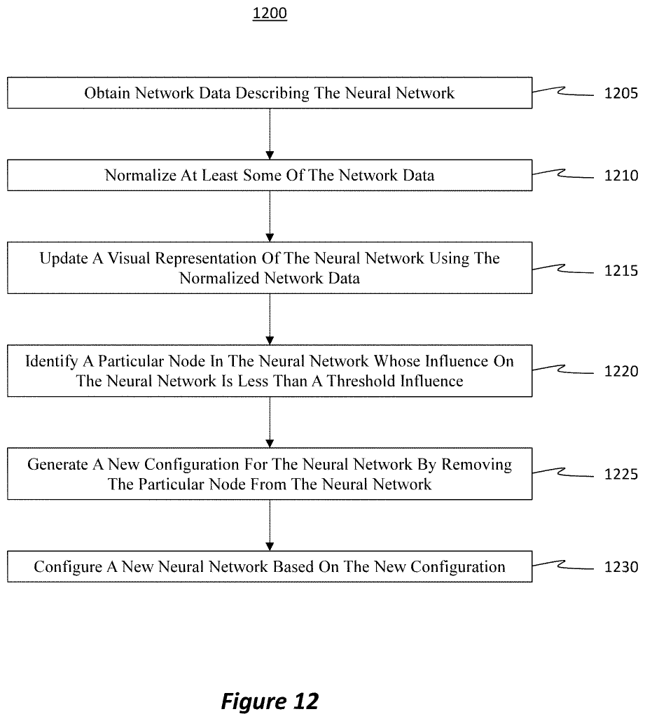

FIG. 12 shows a flowchart of an example method 1200 for refining a neural network. Method 1200 can be implemented within the architecture 200 of FIG. 2A. Furthermore, method 1200 can be implemented by the service 205.

Method 1200 includes an act (act 1205) of obtaining network data describing the neural network. The network data includes state data describing a state of the neural network and structure data describing a structure of the neural network. At least some of the network data is normalized (act 1210). A visual representation of the neural network is then updated (act 1215) using the normalized network data. As a result of updating the visual representation using the normalized network data, a display of nodes and/or of edges in the neural network is modified in a manner to reflect a relative relationship that exists between the nodes and/or the edges. The relative relationship is based on the normalized network data.

Act 1220 includes identifying a particular node in the neural network whose influence on the neural network is less than a threshold influence. For instance, the nodes can be included in a ranked list that is optionally displayed with or within the representation. A threshold influence can be defined, such as perhaps a threshold influence of 1%, 2%, 3%, 4%, 5%, 6%, 7%, 8%, 9%, 10%, or any other selected influence level. If a node's influence is less than the defined threshold influence, then that node can be identified.

Act 1225 involves generating a new configuration for the neural network or perhaps for a subsequent neural network by removing the particular node from the neural network. The new or subsequent neural network is then configured (act 1230) based on the new configuration. This new network will be a relatively simpler network as compared to the previous network; yet, the classification abilities of the new network should be comparable to the previous, more complex network. In this sense, the embodiments are able to generate simplified networks that are able to operate in comparable manners to more complex networks.

In some embodiments, new connections between nodes can be formed when existing nodes are deleted. For instance, suppose a network includes a first hidden layer, a second hidden layer, and a third hidden layer. One or more nodes in the second hidden layer might be deleted. Suppose a node in the first hidden layer and a node in the third hidden layer were both previously connected to the deleted node. Some embodiments can enable those two remaining nodes to connect with one another, to thereby establish a new connection that was not previously included in the earlier neural network. In this manner, the network can optionally reconfigure or rebalance itself based on various deletions of network components (e.g., nodes, edges, etc.).

Although not illustrated in FIG. 12, method 1200 can include additional acts. Some of these acts include identifying a set of one or more nodes whose influence on the neural network exceeds the threshold influence. Another act can include retaining the set of one or more nodes in the network. Another act can include removing, from the neural network, all other nodes whose influence does not meet or exceed the threshold influence. The new neural network is then configured based on the new configuration and based on removal of those other nodes.

Accordingly, the disclosed embodiments provide for improved visualizations of neural networks. Such improved visualizations include the ability to display dynamic network data that was not previously displayable in a real-time, on-demand basis. The embodiments also provide for the intelligent ability to refine and generate new neural networks that are simplified and that are robust.

### Example Computer/Computer Systems

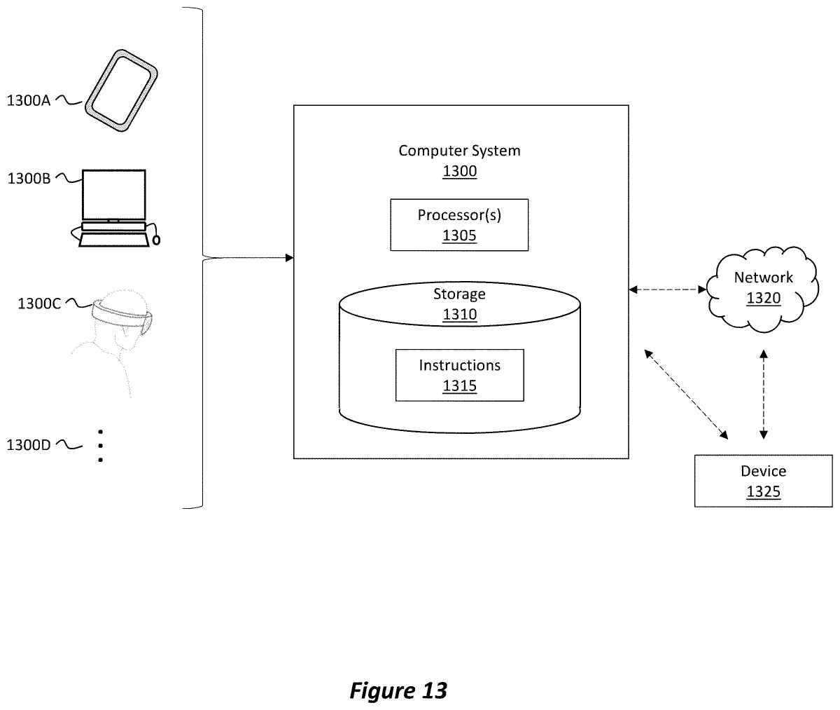

Attention will now be directed to FIG. 13 which illustrates an example computer system 1300 that may include and/or be used to perform any of the operations described herein. Computer system 1300 may take various different forms. For example, computer system 1300 may be embodied as a tablet 1300A, a desktop or a laptop 1300B, a wearable device 1300C, a mobile device, or any other standalone device, as represented by the ellipsis 1300D. Computer system 1300 may also be a distributed system that includes one or more connected computing components/devices that are in communication with computer system 1300.

In its most basic configuration, computer system 1300 includes various different components. FIG. 13 shows that computer system 1300 includes one or more processor(s) 1305 (aka a “hardware processing unit”) and storage 1310.

Regarding the processor(s) 1305, it will be appreciated that the functionality described herein can be performed, at least in part, by one or more hardware logic components (e.g., the processor(s) 1305). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” or “engine” can refer to hardware processing units or to software objects, routines, or methods that may be executed on computer system 1300. The different components, modules, engines, and services described herein may be implemented as objects or processors that execute on computer system 1300 (e.g. as separate threads).

Storage 1310 may be physical system memory, which may be volatile, non-volatile, or some combination of the two. The term “memory” may also be used herein to refer to non-volatile mass storage such as physical storage media. If computer system 1300 is distributed, the processing, memory, and/or storage capability may be distributed as well.

Storage 1310 is shown as including executable instructions 1315. The executable instructions 1315 represent instructions that are executable by the processor(s) 1305 of computer system 1300 to perform the disclosed operations, such as those described in the various methods.

The disclosed embodiments may comprise or utilize a special-purpose or general-purpose computer including computer hardware, such as, for example, one or more processors (such as processor(s) 1305) and system memory (such as storage 1310), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1300 may also be connected (via a wired or wireless connection) to external sensors (e.g., one or more remote cameras) or devices via a network 1320. For example, computer system 1300 can communicate with any number devices (e.g., device 1325) or cloud services to obtain or process data. In some cases, network 1320 may itself be a cloud network. Furthermore, computer system 1300 may also be connected through one or more wired or wireless networks to remote/separate computer systems(s) that are configured to perform any of the processing described with regard to computer system 1300.

A “network,” like network 1320, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1300 will include one or more communication channels that are used to communicate with the network 1320. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for updating a visual representation of a neural network, said method comprising:
after a selected number of iterations in which input data is fed into a neural network, obtaining network data describing the neural network, wherein the network data includes state data describing a state of the neural network and structure data describing a structure of the neural network;
normalizing at least some of the network data;
generating a visual representation of the neural network, wherein the visual representation includes a set of nodes comprising one or more input nodes, one or more hidden layer nodes, and one or more output nodes, and wherein the visual representation further includes edges connecting various ones of said nodes;
updating the visual representation using the normalized network data, wherein, as a result of updating the visual representation using the normalized network data, a display of the nodes and/or of the edges is modified in a manner to reflect a relative relationship that exists between the nodes and/or the edges, and wherein the relative relationship is based on the normalized network data; and
displaying the updated visual representation.

2. The method of claim 1, wherein said normalizing includes;
identifying weights for a subset of nodes that are included in a same layer of the neural network;
computing a range for the weights; and
normalizing each weight by dividing each weight by the computed range.

3. The method of claim 1, wherein the selected number of iterations is at least two iterations.

4. The method of claim 1, wherein the network data further includes weights for the set of nodes.

5. The method of claim 1, wherein said normalizing occurs for each respective layer of the neural network.

6. The method of claim 5, wherein each respective layer of the neural network is normalized differently.

7. The method of claim 1, wherein said normalizing includes;
identifying weights for a subset of nodes that are included in a same layer of the neural network;
computing a range for the weights;
computing an absolute value for each weight; and
normalizing each weight's absolute value by dividing each weight's absolute value by the computed range.

8. The method of claim 1, wherein said normalizing includes;
identifying weights for a subset of nodes that are included in a same layer of the neural network;
computing a range for the weights; and
normalizing each weight's raw value by dividing each weight's raw value by the computed range, wherein a raw value for at least one weight is negative.

9. The method of claim 1, wherein generating the visual representation is performed using a shader.

10. The method of claim 1, wherein generating the visual representation is performed using a three-dimensional (3D) mesh.

11. A computer system that updates a visual representation of a neural network, said computer system comprising:
at least one processor; and
at least one hardware storage device that stores instructions that are executable by the at least one processor to cause the computer system to:
after a selected number of iterations in which input data is fed into a neural network, obtain network data describing the neural network, wherein the network data includes state data describing a state of the neural network and structure data describing a structure of the neural network;
normalize at least some of the network data;
generate a visual representation of the neural network, wherein the visual representation includes a set of nodes comprising one or more input nodes, one or more hidden layer nodes, and one or more output nodes, and wherein the visual representation further includes edges connecting various ones of said nodes;
update the visual representation using the normalized network data, wherein, as a result of updating the visual representation using the normalized network data, a display of the nodes and/or of the edges is modified in a manner to reflect a relative relationship that exists between the nodes and/or the edges, and wherein the relative relationship is based on the normalized network data; and
display the updated visual representation.

12. The computer system of claim 11, wherein the state data includes weights and thresholds for the set of nodes.

13. The computer system of claim 11, wherein the iterations are a part of a training phase for the neural network.

14. The computer system of claim 11, wherein the iterations are a part of an evaluation phase for the neural network where the neural network is being tuned.

15. The computer system of claim 11, wherein the selected number of iterations is based on a determination as to whether the neural network has reached a convergence state.

16. The computer system of claim 11, wherein said normalizing includes:
identifying weights for a subset of nodes that are included in a same layer of the neural network;
identifying a first weight having a highest value among said weights;
identifying a second weight having a lowest value among said weights;
computing a range by subtracting the lowest value from the highest value; and
normalizing each weight by dividing each weight by the computed range.

17. The computer system of claim 11, wherein modifying the display of the nodes and/or of the edges includes modifying a displayed thickness of the nodes and/or edges.

18. The computer system of claim 11, wherein modifying the display of the nodes includes modifying a border of at least one node.

19. A method for updating a visual representation of a neural network, said method comprising:
after a selected number of iterations in which input data is fed into a neural network, obtaining network data describing the neural network, wherein the network data includes state data describing a state of the neural network and structure data describing a structure of the neural network;
normalizing at least some of the network data, wherein said normalizing includes:
identifying weights for a subset of nodes that are included in a same layer of the neural network;
identifying a first weight having a highest value among said weights;
identifying a second weight having a lowest value among said weights;
computing a range by subtracting the lowest value from the highest value; and
normalizing each weight by dividing each weight by the computed range;
generating a visual representation of the neural network, wherein the visual representation includes a set of nodes comprising one or more input nodes, one or more hidden layer nodes, and one or more output nodes, and wherein the visual representation further includes edges connecting various ones of said nodes;
updating the visual representation using the normalized network data, wherein, as a result of updating the visual representation using the normalized network data, a display of the nodes and/or of the edges is modified in a manner to reflect a relative relationship that exists between the nodes and/or the edges, and wherein the relative relationship is based on the normalized network data; and
displaying the updated visual representation.

20. The method of claim 19, wherein modifying the display of the nodes includes modifying a border of at least one node.
